(19) United States
(12) Patent Application Publication
(10) Pub. No.: US 2014/0375901 A1
(43) Pub. Date: Dec. 25, 2014

(54) COMPUTING DEVICE AND CASE HAVING ADJUSTABLE SHADE

(71) Applicant: Benjamin R. STOCKETT, Lebanon, NH (US)

(72) Inventor: Benjamin R. STOCKETT, Lebanon, NH (US)

(21) Appl. No.: 13/923,575

(22) Filed: Jun. 21, 2013

(51) Int. Cl. H04N 5/64

(52) U.S. Cl. CPC H04N 5/64
USPC 348/838; 206/216

(57) ABSTRACT

A handheld computing device is disclosed. The handheld computing device may have a frame, and a video screen supported within the frame. The handheld computing device may also have a shade operatively connected to the frame and adjustable to block light from the video screen.

### TECHNICAL FIELD

The present disclosure relates generally to a computing device and case, and more particularly, to a handheld computing device and carrying case having an adjustable shade.

### BACKGROUND

Handheld computing devices are well known in the art. Exemplary devices include PDAs (Personal Digital Assistants), gaming systems, tablets, smart phones, etc. These devices incorporate video screens that are used to display information to a user under a variety of conditions, and an interface (e.g., buttons, toggle switches, keypads, and touch screen technology) that allows the user to control or respond to information displayed on the video screen. In order to enhance use of the computing devices, the user needs to be able to clearly discern the information displayed on the video screen.

Unfortunately, ambient conditions can affect the user's ability to discern the information displayed on the video screen. For example, information displayed on the video screen can be difficult to see when bright light is directed onto the screen. In some situations, the computing device can be turned such that the video screen is shaded from the light by nearby objects or by the computing device itself. In other situations, however, this may be inconvenient or even impossible. For example, a passenger using a handheld computing device while seat-belted inside a vehicle, may not be able to easily move to another location within the vehicle while the vehicle is moving. Similarly, the passenger may not be able to even reorient themselves or the computing device to a convenient location where the interface is still accessible.

The disclosed handheld computing device, carrying case, and shade are directed to overcoming one or more of the problems set forth above and/or other problems of the prior art.

### SUMMARY

One aspect of the present disclosure is directed to a handheld computing device. The handheld computing device may include a frame, and a video screen supported within the frame. The handheld computing device may also include a shade operatively connected to the frame and adjustable to block light from the video screen.

In another aspect, the present disclosure is directed to a carrying case for a handheld computing device. The carrying case may include a base, and a plurality of sidewalls extending from a periphery of the base to form a generally hollow enclosure configured to receive the handheld computing device. The carrying case may also include a cover operatively attached to at least one of the plurality of side walls and movable from an open position at which the handheld computing device can be accessed, to a closed position at which the handheld computing device is secured within the enclosure. The carrying case may further include a shade operatively connected to at least one of the plurality of side walls and the cover. The shade may be adjustable to block light from a video screen of the handheld computing device while the handheld computing device is in seated in the enclosure and the cover is in the open position.

### BRIEF DESCRIPTION OF THE DRAWINGS

FIG. 1 is a pictorial illustration of an exemplary disclosed handheld computing device;

FIG. 2 is a pictorial illustration of another exemplary disclosed handheld computing device; and

FIG. 3 is a pictorial illustration of an exemplary disclosed carrying case that may be used in conjunction with the handheld computing devices of FIGS. 1 and 2.

### DETAILED DESCRIPTION

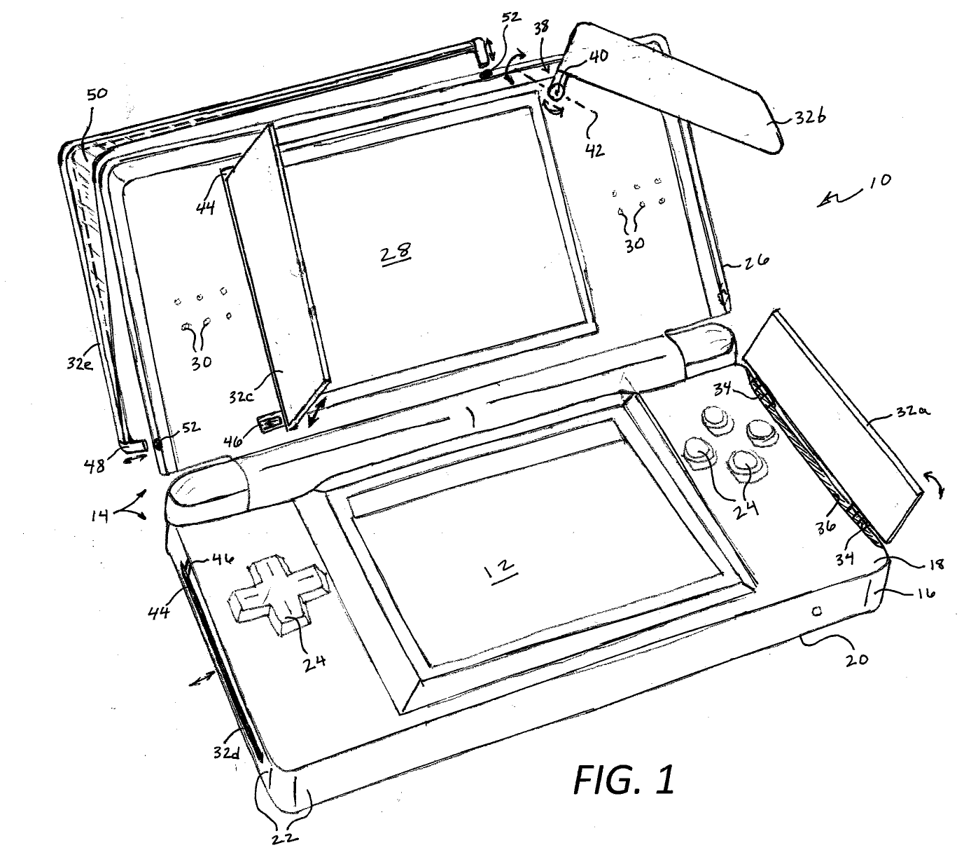

FIG. 1 illustrates an exemplary handheld computing device 10. For the purposes of this disclosure, a handheld computing device may be considered a portable electronic device having a display screen 12 and a processor (not shown), that is small enough to be held in the hands of a user. Display screen 12 of handheld computing device 10 may be equipped with touch input and/or a miniature keyboard, and the processor (not shown) may be configured to run an operating system with various types of application software, known as apps. Handheld computing device 10 can also be equipped with WI-FI, Bluetooth and/or GPS capabilities that can allow connections to the Internet and other Bluetooth capable devices such as an automobile or a microphone headset. A camera or media player feature for video or music files can also be found on handheld computing device 10, along with a conventional battery power source such as a lithium battery. In the disclosed example, handheld computing device 10 is a gaming console. It is contemplated, however, that handheld computing device 10 could alternatively embody a smartphone, a personal digital assistant, an ultra-mobile PC, a tablet PC, an MP3 player, a mobile television receiver, or another computing device known in the art.

Display screen 12 may be set with a frame 14 that forms the general structure of handheld computing device 10. Frame 14 may include, among other things a base portion 16 having a face 18, a bottom surface 20 oriented opposite face 18, and a plurality of side surfaces 22 that join face 18 to bottom surface 20. Face 18 may be configured to receive display screen 12. In some embodiments, face 18 may also be configured to receive one or more interface devices 24, for example buttons, toggle switches, dials, etc.

In the disclosed embodiment, frame 14 is generally rectangular, having a length direction, a width direction, and a thickness. Display screen 12 may also be generally rectangular and set within an approximate center of face 18, such that a length and a width of display screen 12 are generally aligned with the length and width directions of frame 14. Interface devices 24 may be situated at edges of display screen 12 in the length and/or width directions. It is contemplated, however, that frame 14 and/or display screen 12 may be another shape, if desired, for example square, elliptical, or another suitable shape.

Frame 14 may also include a top portion 26 that is pivotally connected to base portion 16. Top portion 26 may generally have the same width and length as base portion 16, and be configured for use as a cover for base portion 16. In some embodiments, a second display screen 28 and/or audio output (e.g., speakers) 30 may be set within an internal face of top portion 22, in general alignment with face 18. It is contemplated that top portion 22 may be omitted, if desired.

Handheld computing device 10 may be equipped with one or more adjustable sun shades 32. It should be noted that, while handheld computing device 10 of FIG. 1 is shown as having five different types of sun shades positioned at different locations, handheld computing device 10 may have any number and configuration of sun shades at any suitable position. FIG. 1 illustrates a first sun shade 32a, a second sun shade 32b, a third sun shade 32c, a fourth sun shade 32d, and a fifth sun shade 32e. Each of sun shades 32a-32d may be adjustable in some manner to block direct sunlight onto display screens 12 and/or 28 from multiple different directions.

Sun shade 32a may be a generally plate like base member that is pivotally connected to frame 14. In the disclosed embodiment, sun shade 32a is pivotally connected to an edge of base portion 16, for example to an edge of face 18 and or one of side surfaces 22 by way of one or more hinges 34. Hinges 34 may be generally aligned with the edge of face 18 and/or side surface 22, positioned along a lengthwise edge of sun shade 32a, and configured to pivot sun shade 32a between an actuated position (shown in FIG. 1) and a stowed position. In a first embodiment, the stowed position may be a position within a recess 36 formed in frame 14 (e.g., formed within one or more of side surfaces 22), such that little (if any) of sun shade 32a protrudes beyond an external boundary of face 18 and/or side surfaces 22. In this configuration, sun shade 32a may have a width about the same or less than a thickness of base portion 16. In a second embodiment, the stowed position of sun shade 32a may be generally parallel with face 18 (i.e., sun shade 32a may pivot down to lay on top of face 18 and/or screen 12), such that sun shade 32a may have a greater width than in the first embodiment. In yet another embodiment, the stowed position of sun shade 32a may be at side surface 22 and not within recess 36. In any of these configuration, sun shade 32a may pivot from the stowed position through a plurality of actuated positions at different angles (e.g., through about 90° or more) toward and/or away from display screen 12. It should be noted that, while sun shade 32a is shown as being located at the right side of handheld computing device 10 (relative to the perspective of FIG. 1), it is contemplated that sun shade 32 may alternatively be located toward the left side, the bottom side, or the top side, as desired. It is further contemplated that although sun shade 32a is shown at an edge of face 18 and side surfaces 22, sun shade 32a could alternatively be located within face 18 (i.e., closer to display screen 12), or anywhere within top portion 26.

Sun shade 32b, in contrast to sun shade 32a, may be pivotally connected to handheld computing device 10 at only one corner. In particular, a pivot member 38 may join one corner of sun shade 32b to handheld computing device 10, for example to a portion of handheld computing device 10 at a corner of display screens 22 and/or 28. Pivot member 38 may have any form known in the art and be configured to pivot in any number of different directions. For example, pivot member 38 may pivot about a first pivot axis 40 in a plane generally parallel with display screens 28 and/or 22, and about a second pivot axis 42, in a plane generally perpendicular to display screens 28, 22. With this configuration, sun shade 32b may be located to block light from a side of display screens 22, 28 and/or from a top of display screens 22, 28, while also being tiltable through a range of angles to different heights. Although shown as being connected to top portion 26, at a corner of display screen 28, sun shade 32b may be connected at any suitable location. It is also contemplated that sun shade 32b may have any desirable shape, for example rectangular (like sun shade 32) or tapered toward one end (shown in FIG. 1).

Sun shade 32c, unlike sun shades 32a and 32b, may move linearly from a stowed position within frame 14 to an actuated position (shown in FIG. 1). In the disclosed embodiment, sun shade 32c is located to the left of display screen 12 and generally aligned with an edge of display screen 12. It is contemplated, however, that sun shade 32c may alternatively or additionally be located at other locations, for example at an upper edge of display screen 12 or at an upper or lower edge of display screen 28. When sun shade 32c is stowed within frame 14 (e.g., within a slot 44 of frame 14), a latch 46 or other closure mechanism may be used to retain sun shade 32c in position. Sun shade 32c may be spring-biased out of slot 44, if desired, such that movement of latch 46 results in an autonomous extending motion of sun shade 32c. It is contemplated that sun shade 32c could additionally be hinged to frame 14, if desired, such that after full extension, sun shade 32c could then be pivoted to a desired angle.

Sun shade 32d may be similar to sun shade 32c, but positioned within one of side surfaces 22. That is, slot 44 may be formed within side surface 22 and, after movement of latch 46, sun shade 32d may extend outward away from side surface 22 through slot 44. After extension, sun shade 32d may then be pivoted toward display screens 12 and/or 28 to a desired angle. Sun shade 32d may afford a greater width and sun-blocking ability, as compared with sun shade 32c. Sun shade 32c, being located closer to display screens 12 and/or 28, however, may not need to be as wide as sun shade 32d.

Sun shade 32e may be a detachable shade, and configured to simultaneously block sun from two or more different directions. In particular, sun shade 32e may be generally L-shaped, having two plate-like base members arranged at about 90° relative to each other, and removably attachable to two adjoining side surfaces 22, for example to left- and upper-side surfaces 22 of top portion 26 or to right- and upper-side surfaces 22. Sun shade 32e may include a frame portion 48 (e.g., a tubular frame portion), and a canopy portion 50 that is connected to frame portion 48. In the disclosed embodiment, canopy portion 50 may protrude from frame portion 48 toward display screens 12 and/or 28, and, in some instances, protrude a greater amount at a corner of frame portion 48. Frame portion 48 may be connectable to frame 14 of handheld computing device 10 in a variety of different ways. For example, ends of frame portion 48 could be configured to engage corresponding holes 15 formed within side surfaces 22. Alternatively, clips, magnets, fasteners, or other connecting members may be utilized, as desired. Although not shown, the two legs of sun shade 32e that form the general L-shape may be about the same length, such that sun shade 32e may be moved from the left/upper corner of handheld computing device to the right/upper corner, as necessary.

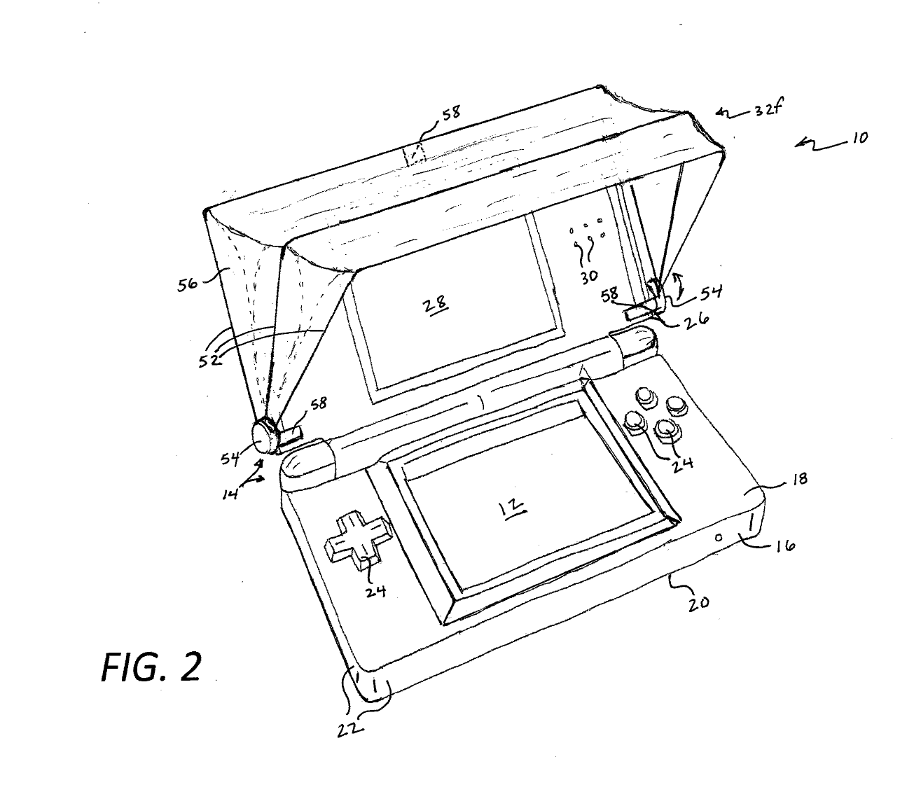

FIG. 2 illustrates an additional sun shade embodiment, sun shade 32f. Sun shade 32f may be a collapsible sun shade, having a plurality of frame members 52 connected at a common pivot 54, and a flexible canopy 56 that is connected to frame members 52. A first of frame members 52 may be attached to frame 14 of handheld computing device 10, for example to top portion 18 by way of one or more clips 58, and all of frame members 14 may be formed to generally frame or surround top portion 18. Although FIG. 2 illustrates three separate frame members 52, it is contemplated that any number of frame members 52 may be included. The embodiment of FIG. 2 includes three frame members. In this configuration, after the first frame member 52 is attached to top portion 18, the two remaining frame members 52 may be rotated away from the first frame member 52 about common pivot 54. As frame members 52 are rotated away from each other, canopy 56 may unfold to form a cover that protrudes at least over the top of display screen 28. In the disclosed embodiment, canopy 56 includes three sides and, accordingly, protrudes over the top and two opposing sides of display screen 28 to simultaneously shade display screen 28 from multiple directions. Sun shade 32f may be completely removed from handheld computing device 10 for storage or, alternatively, collapsed into a stowed position against side surfaces 22, as desired.

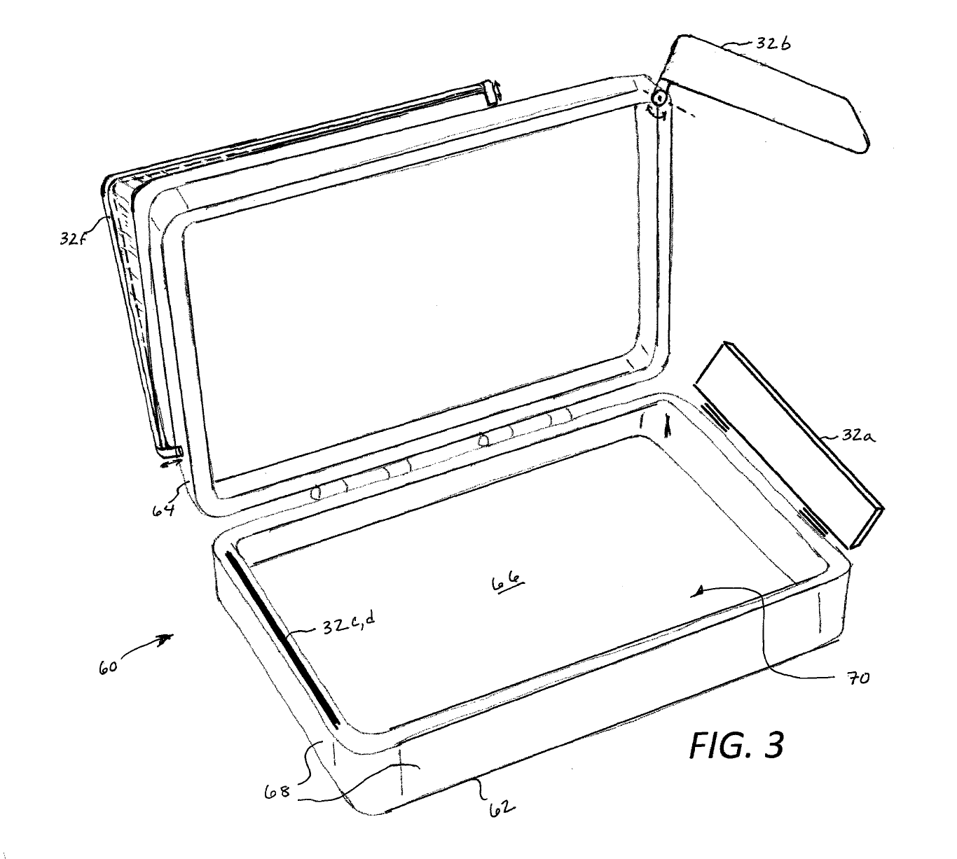

FIG. 3 illustrates a carrying case 60 that may be used together with handheld computing device 10. Carrying case 60 may be configured to receive handheld computing device 10, and one or more of sun shades 32a-32f may be connected to carrying case 60 to block sun from handheld computing device 10 while handheld computing device 10 is held within carrying case 60. It should be noted that carrying case 60 may take any conventional form known in the art, and that the configuration of FIG. 3 is exemplary only.

The exemplary carrying case 60 shown in FIG. 3 may include a bottom portion 62 and a cover 64 that is pivotally connected to bottom portion 62. Bottom portion 62 may include a base 66 and a plurality of side walls 68 that extend from a periphery of base 66 to form an enclosure 70 that receives handheld computing device 10. With this configuration, cover 64 may be pivoted away from bottom portion 62, and handheld computing device 10 may be utilized while it remains within bottom portion 62. It is contemplated that cover 64 may be omitted if desired. Any one or more of sun shades 32a-32f may be connected to side walls 68 (e.g., within pockets formed in side walls 68, to external surfaces, to distal end surfaces, at corners, etc.) in any desired manner.

### INDUSTRIAL APPLICABILITY

The disclosed sun shades may be applicable to any handheld computing device and/or carrying case for use in blocking direct sunlight from one or more display screens of the handheld computing device. This functionality may increase user comfort, while also extending usability of the handheld computing device.

It will be apparent to those skilled in the art that various modifications and variations can be made to the disclosed handheld computing device, carrying case, and shade. Other embodiments will be apparent to those skilled in the art from consideration of the specification and practice of the disclosed handheld computing device, carrying case, and light shade. It is intended that the specification and examples be considered as exemplary only, with a true scope being indicated by the following claims and their equivalents.

What is claimed is:

1. A handheld computing device, comprising:
a frame;
a video screen supported within the frame; and
a shade operatively connected to the frame and adjustable to block light from the video screen.

2. The handheld computing device of claim 1, wherein the shade is stowable within the frame.

3. The handheld computing device of claim 1, wherein the shade is removably connected to the frame.

4. The handheld computing device of claim 1, wherein the shade is pivotal from a first position at which light is blocked from a first direction through about 90° to a second position at which light is blocked from a second direction.

5. The handheld computing device of claim 1, wherein the frame includes a recess configured to receive the shade.

6. The handheld computing device of claim 1, wherein the shade is operatively connected to a face of the frame in which the video screen is seated.

7. The handheld computing device of claim 1, wherein:
the frame includes a face in which the video screen is seated, and opposing sides connected to the face; and
the recess is located within one of the opposing sides.

8. The handheld computing device of claim 1, wherein:
the frame includes a face in which the video screen is seated, and opposing sides connected to the face; and
the shade is connected to the frame at a corner of the face.

9. The handheld computing device of claim 8, wherein the shade is generally L-shaped.

10. The handheld computing device of claim 1, wherein:
the frame includes:
a base portion configured to receive the video screen; and
a top portion pivotally connected to the base portion; and
the shade is connected to the top portion.

11. The handheld computing device of claim 10, wherein:
the video screen is a first video screen;
the shade is a first shade; and
the handheld computing device includes:
a second video screen supported within the top portion; and
a second shade operatively connected to the frame and adjustable to block light from the video screen in the bottom portion.

12. The handheld computing device of claim 1, wherein the shade includes:
a collapsible frame; and
a flexible canopy attached to the collapsible frame.

13. A carrying case for a handheld computing device, comprising:
a base;
a plurality of sidewalls extending from a periphery of the base to form a generally hollow enclosure configured to receive the handheld computing device;
a cover operatively attached to at least one of the plurality of side walls and movable from an open position at which the handheld computing device can be accessed to a closed position at which the handheld computing device secured within the enclosure; and
a shade operatively connected to at least one of the plurality of side walls and the cover, the shade being adjustable to block light from a video screen of the handheld computing device while the handheld computing device is in seated in the enclosure and the cover is in the open position.

14. The carrying case of claim 13, wherein the shade is pivotally connected to the at least one of the plurality of side walls and the cover.

15. The carrying case of claim 13, wherein the shade is stowable within the at least one of the plurality of side walls and the cover.

16. The carrying case of claim 13, wherein the shade is removably connected to the at least one of the plurality of side walls and the cover.

17. The carrying case of claim 13, wherein the shade is generally L-shaped.

18. The carrying case of claim 13, wherein:
the shade is a first shade operatively connected to at least one of the plurality of side walls; and
the carrying case includes a second shat operatively connected to the cover.

19. A shade for a handheld computing device, the shade comprising:
a generally plate-like base member; and
an attachment mechanism configured to adjustably and removably connect the base portion to the handheld computing device.

20. The shade of claim 19, wherein:
the generally plate-like base member is a first generally plate-like base member; and
the shade further includes a second generally plate-like base member connected to the first generally plate-like base member at about a 90° orientation.
